(19) United States
(12) Patent Application Publication
(10) Pub. No.: US 2026/0316635 A1
(43) Pub. Date: Oct. 15, 2026

(54) SYSTEMS AND METHODS FOR A VEHICLE SMART HEAD RESTRAINT

(71) Applicant: TOYOTA MOTOR ENGINEERING & MANUFACTURING NORTH AMERICA, INC., Plano, TX (US)

(72) Inventors: John D. Harkleroad, Ypsilanti, MI (US); Manish Shah, Canton, MI (US)

(73) Assignees: TOYOTA MOTOR ENGINEERING & MANUFACTURING NORTH AMERICA, INC., Plano, TX (US); TOYOTA JIDOSHA KABUSHIKI KAISHA, Toyota-shi, Aichi-ken (JP)

(21) Appl. No.: 19/173,953

(22) Filed: Apr. 9, 2025

(51) Int. Cl. B60N 2/02; B60N 2/22; B60N 2/853

(52) U.S. Cl. CPC B60N 2/0252; B60N 2/2213; B60N 2/853

(57) ABSTRACT

Systems and methods to adjust head restraint backsets based on a recline angle of the seat are provided. The disclosed systems are designed to provide a constant head restraint backset to the seat occupant to prevent “headrest too close” complaints and to prevent the backset from increasing to a range that is so large that it can cause Insurance Institute for Highway Safety (IIHS) rating or related issues.

### TECHNICAL FIELD

The subject matter described herein relates generally to vehicle safety and, more particularly, to smart head restraints for vehicle seats.

### BACKGROUND

To achieve a Top Safety Pick Plus rating, car manufacturers must meet certain criteria. Historically, safety ratings have only been performed in a single position and with a single test dummy. In the future, however, it is expected that rating systems will change, and the head restraint will be tested by various size occupants and in multiple positions. Therefore, it will become necessary to keep the head restraint backset consistent for all occupants.

### SUMMARY

In view of the foregoing, the various embodiments described herein provide systems and methods to adjust a vehicle head restraint backset based on a tilt/recline angle of the seat. A generalized method includes adjusting the backset with respect to a vehicle seat recline angle based upon a non-linear relationship between the vehicle seat recline angle and backset. The non-linear relationship is different for a driving posture recline angle range, resting posture recline angle range, and a sleeping posture recline angle range.

Another generalized embodiment of the present disclosure provides a system to adjust a vehicle head restraint backset based on a recline angle of a seat. The system includes a seat recline adjustment mechanism and head restraint adjustment mechanism. The seat recline adjustment mechanism is configured to recline the seat relative to a reference position. The head restraint adjustment mechanism is configured to adjust the backset with respect to the seat recline angle based upon a non-linear relationship between the seat recline angle and backset. The non-linear relationship is different for a driving posture recline angle range, resting posture recline angle range, and a sleeping posture recline angle range.

In yet another generalized embodiment, a vehicle includes a seat, seat recline adjustment mechanism and head restraint adjustment mechanism. The seat includes a back support and head restraint. The seat recline adjustment mechanism is configured to recline the back support relative to a reference position. The head restraint adjustment mechanism is configured to adjust a backset of the head restraint with respect to a seat recline angle based upon a non-linear relationship between the seat recline angle and backset. The non-linear relationship is different for a driving posture recline angle range, resting posture recline angle range, and a sleeping posture recline angle range.

This Summary is provided to introduce a selection of concepts in a simplified form that are further described below in the Detailed Description. This Summary is not intended to identify key features or essential features of the claimed subject matter, nor is it intended to limit the scope of the claimed subject matter. A more extensive presentation of features, details, utilities, and advantages of the system, as defined in the claims, is provided in the following written description of various embodiments of the disclosure and illustrated in the accompanying drawings.

### BRIEF DESCRIPTION OF THE DRAWINGS

Illustrative embodiments of the present disclosure will be described with reference to the accompanying drawings, of which:

FIG. 1A illustrates current IIHS geometric zones useful to illustrate certain advantages of the present disclosure.

FIG. 1B is a side perspective view summarizing the features of the present disclosure.

FIG. 2A is a chart plotting the backset (BS) vs. torso (back support) angle, according to certain illustrative embodiments of the present disclosure.

FIG. 2B is an expansion of the chart of FIG. 2A showing torso angles from 30°-90° and a BS range of −250-100 mm.

FIG. 3 shows skeletal representation useful to illustrate features of the present disclosure.

FIG. 4 is a diagrammatic illustration of a backset adjustment system for a vehicle in accordance with at least one embodiment of the present disclosure.

FIG. 5 is a flow chart for a method to adjust a vehicle head restraint backset based on a recline angle of a seat, according to certain illustrative embodiments of the present disclosure.

FIG. 6 is a schematic diagram of a processor circuit 650, in accordance with at least one embodiment of the present disclosure.

### DETAILED DESCRIPTION

In view of the foregoing, the present disclosure is generally directed to systems and methods to adjust head restraint backsets based on a recline angle of the seat. The disclosed systems are designed to provide a controlled head restraint backset to the seat occupant to prevent “headrest too close” complaints and to prevent the backset from increasing to a range that is so large that it can cause Insurance Institute for Highway Safety (IIHS) rating or related issues.

As mentioned above, to achieve a Top Safety Pick Plus rating, vehicle manufacturers must meet certain criteria. Historically, this has only been performed in a single position and with a single test dummy, e.g., Bio-Rid. In the future, however, rating systems will change, and the head restraint will be tested by various size occupants and in multiple positions. Therefore, it will become necessary to keep the head restraint backset consistent for all occupants. Moreover, such systems will increase the safety of vehicle occupants leading to improved overall vehicle safety.

The systems described herein may be implemented manually or as a process at least partially implemented on a display, and operated by a control process executing on a processor that may accept user inputs from a suitable user-interface and other control devices, and that is in communication with one or more modules and remote processors. In that regard, the control process may perform certain specific operations in response to different inputs or selections made at different times, and/or in response to real-time or near-real-time user inputs.

For the purposes of promoting an understanding of the principles of the present disclosure, reference will now be made to the embodiments illustrated in the drawings, and specific language will be used to describe the same. It is nevertheless understood that no limitation to the scope of the disclosure is intended. Any alterations and further modifications to the described devices, systems, and methods, and any further application of the principles of the present disclosure are fully contemplated and included within the present disclosure as would normally occur to one skilled in the art to which the disclosure relates. It is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately.

These descriptions are provided for exemplary purposes, and should not be considered to limit the scope of the vehicle seat head restraint backset adjustment system described herein. Certain features may be added, removed, or modified without departing from the spirit of the claimed subject matter.

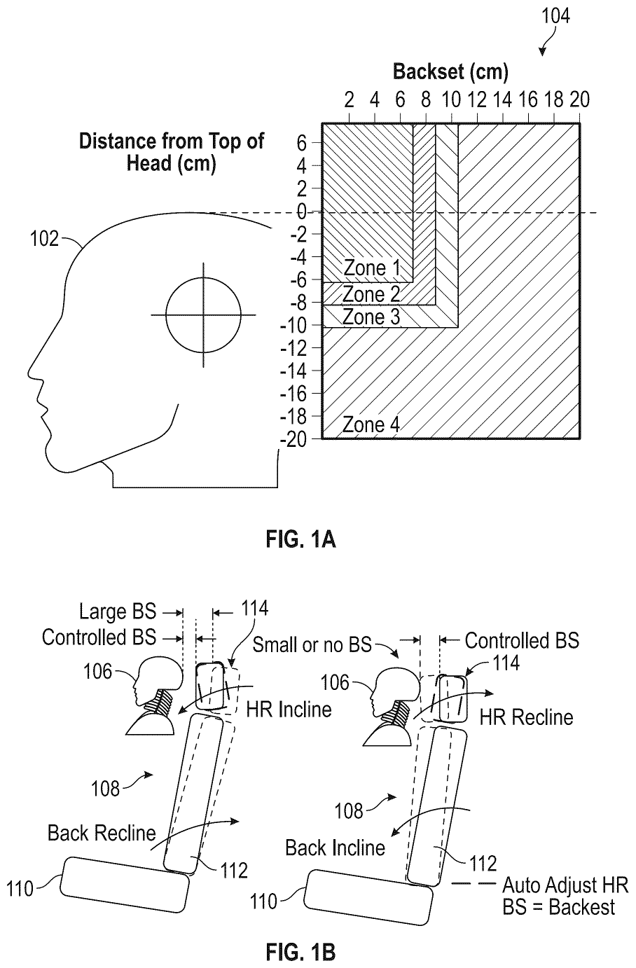

FIG. 1A illustrates current IIHS geometric zones useful to illustrate certain advantages of the present disclosure. A head 102 is shown adjacent a chart representation of IIHS geometric zones 104. The y-axis shows the distance of the head restraint (not shown) from the top of head 102 (in cm), while the x-axis shows the backset distance from head 102 (in cm). The backset is the distance between the back of head 102 and the head restraint. IIHS geometric zones 104 include Zone 1, Zone 2, Zone 3 and Zone 4. Zone 1 is the best or safest according to IIHS and zone 4 is the worst or least safe.

FIG. 1B is a side perspective view summarizing the features of the present disclosure. A seat occupant 106 is positioned in a seat 108 comprised of a seat cushion 110, back support 112 and head restraint 114. The left-side shows seat 108 reclining, while the right-side shows seat 108 inclining. As the seat 108 reclines, head restraint 114 inclines to maintain the backset (BS) in a safe zone. As seat 108 inclines, head restraint 114 reclines to maintain the BS in a safe zone (shown as the controlled backset). As will be described herein, the controlled BS can be accomplished by a mechanical ratio of the seat recliner (mechanism that reclines back support 112 to desired angle) to the head restraint recliner (mechanism that reclines head restraint 114 to desired angle). Here, for example, seat 108 can be manually adjusted whereby the seat occupant can manually recline back support 112. Then, head restraint 114 automatically reclines as necessary to maintain a safe zone BS based upon the mechanical ratio. In such embodiments, the seat recline adjustment mechanism and head restraint adjustment mechanism are pre-set to the mechanical ratio. A variety of electromechanical devices may be used as the adjustment mechanisms such as, for example, power motors or similar mechanical movers, as will be understood by those ordinarily skilled in the art having the benefit of this disclosure.

Alternatively, a processor can automatically adjust head restraint 114 as the angle of seat support 112 is adjusted. In such an example, a power motor ratio may be utilized via a pulse width modulation technique, along with one or more sensors to measure the BS and adjust head restraint 114 automatically. Here, for example, the seat occupant can press a button or otherwise initiate electronic inclination/reclination of seat 108, whereby the processor automatically adjusts the BS (via some powered motor, e.g.) in response to sensor detection of the recline angle of back support 112.

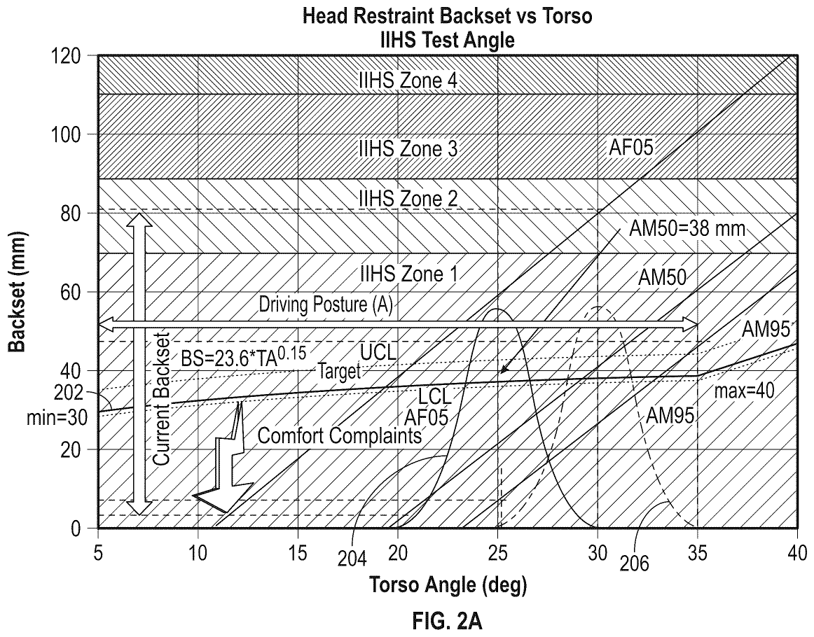

FIG. 2A is a chart plotting the BS vs. torso (back cushion) angle, according to certain illustrative embodiments of the present disclosure. The y-axis reflects the BS in mm and the x-axis is torso angle in degrees. As will be discussed, the chart was used to determine the optimal BS vs. torso angles. Using conventional recline and head restraint designs, the BS varies as shown in the three diagonal lines for AF05, AM50, and AM95 (American Female 5^{th} percentile, American male 50^{th} percentile, American male 95^{th} percentile, respectively). This shows that the BS increases roughly at 4 mm per degree of recline (slope of the lines) of back support 112.

Another concept for this disclosure is shown by line 202 in FIG. 2A. For purposes of driving, the BS is controlled with respect to the torso angle according to the line 202, which is a non-linear driving target curve for all torso/back support 112 angles up to and including 35° (which is at the upper end of the bell curve for AM95), also referred to as the driving posture recline angle range. Thus, in certain illustrative embodiments, the optimum backset (Eq.1) for torso angles (TA) from 0°-35° (the driving posture recline angle range) may be provided according to the following non-linear relationship:

BS=23.6*TA^{0.15} Eq. (1)

Thus, the illustrative systems described herein may be configured to automatically (or manually) adjust the BS with respect to the torso angle in accordance with the above relationship in Eq. (1) for torso angles in the range 0°-35°. As can be seen, the preferred recline distribution for AF05 is identified by 204, while the preferred recline distribution for AM95 is identified by 206.

When the torso angle TA exceeds 35°, the BS is allowed to increase so the seat occupant can, for example, take a nap during charging of an EV or just take a rest break, also referred to as the resting posture. The resting posture recline angle range is 36°-54°. FIG. 2B is an expansion of the chart of FIG. 2A showing torso angles from 30°-90° and a BS range of −250-100 mm. As shown in FIG. 2B, the resting posture may be defined as extending between torso angles of 36° and 54°.

In certain illustrative embodiments, the optimum relationship between the target backset BS2 and torso angle TA for resting posture torso angles 36°-54° can be defined by a second-degree polynomial relationship (i.e., ax²+bx+c). More particularly, via testing, it was determined the optimum relationship between the target backset BS2 and torso angle TA for resting posture torso angles 36°-54° can be expressed by the following non-linear relationship:

BS2=01048*TA²−2*TA+50 Eq. (2)

Thus, the illustrative systems described herein may be configured to automatically adjust the backset with respect to the torso angle in accordance with the above relationship Eq. (2) for torso angles in the range 36°-54°.

For torso angles above 54°, various sleeping postures may be defined, and the system may be configured to control the backset in accordance with the determined sleeping posture curves shown in FIG. 2B. For example, for optimum user comfort when the user is sleeping on his/her back in the vehicle seat, the system may be configured to automatically (or manually) adjust the backset with respect to the torso angle in accordance with the default “back sleeping posture” curve shown in FIG. 2B. Also, for optimum user comfort when the user is sleeping on his/her side in the vehicle seat, the system may be configured to automatically adjust the backset with respect to the torso angle in accordance with the default “side sleeping posture” curve shown in FIG. 2B.

In yet other embodiments, the system may also enable manual override of the default “back sleeping posture” and “side sleeping posture” backset control curves within the torso angle range of 54°-90°, to enable a user to make fine adjustments to the BS as desired for maximum comfort according to personal preferences.

While resting, reading a book or looking at a phone or iPad device the Resting Posture recline angle range (B) would be preferred. This zone is controlled as a 2nd order for backset versus torso angle. However, when sleeping during an overnight stop, or charging an EV, the Sleeping Posture (C) may be preferred. In this example, Sleeping Posture C needs a much broader range of backset as some people are back sleepers and others are side sleepers. Thus, in one embodiment, there is a recommended target set for side sleepers and back sleepers in the design. However, the seat occupant would be able to adjust this to any position once the recline angle is above the 54-degree threshold, which provides the seat occupant a selectable position without needing a pillow. Accordingly, the three zones (driving, resting and sleep postures) provide the seat occupant with the ideal backset to match their usage conditions.

The target ranges described herein are, in part, based on the backset and the distance vertically and horizontally from the C7 vertebrae to the occipital protuberance. Using this as the zero-degree angle for spinal alignment, the other postures for comfort were calculated.

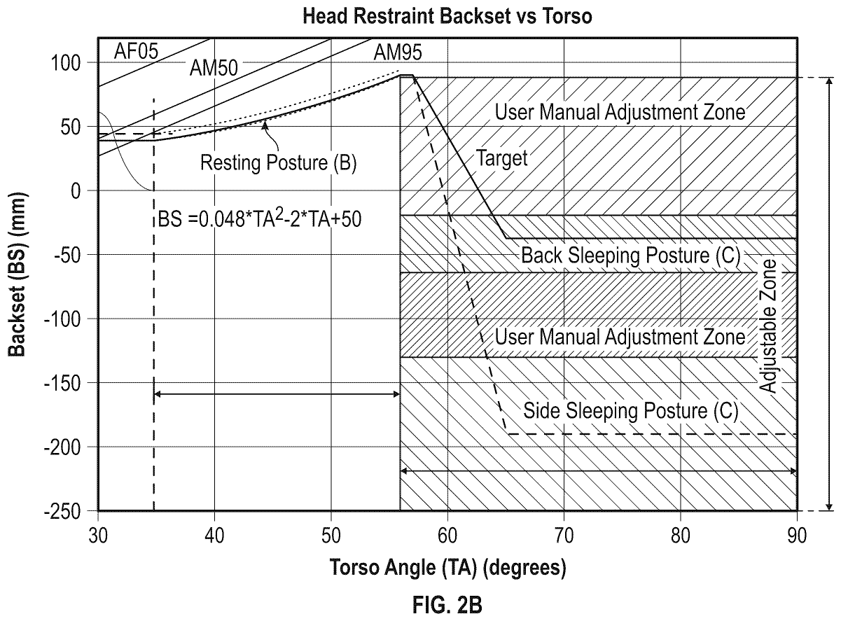

A side sleeper has a completely different need (vs. a back sleeper). The side gap or distance from the shoulder to the head can be quite large. FIG. 3 shows skeletal representation useful to illustrate this feature of the present disclosure. A side gap (SG) is illustrated. As such the backset target would be different versus that of the back sleeper, and may be adjusted automatically or manually to a comfortable SG accordingly.

In other aspects of the present disclosure, information from vehicle sensors may be used to determine or estimate pertinent physical parameters (e.g., side gap, distance between the external occipital protuberance and the vertebra prominins, etc.) of an individual seat occupant. Vehicle sensors may also detect an orientation of the occupant in the seat (e.g., whether the occupant is lying on his back or on his side). Using the occupant physical parameters, the system may automatically estimate an optimal backset or side gap for the individual occupant. Embodiments of the present disclosure may then automatically adjust the headrest position relative to the occupant's head and neck to achieve an optimal headrest position based on the determined orientation of the occupant in the seat.

In yet other embodiments, the system automatically adjusts the position or orientation of head restraint 114 based on a profile of the seat occupant saved in system memory. In other embodiments, the system is adapted to detect an approaching driver or occupant, scan and profile that person per AF05/AM50 and AM95 categories using cameras or radar located on the exterior or interior of the vehicle. Once detected, the system automatically sets the seats to the driving posture or other desired posture.

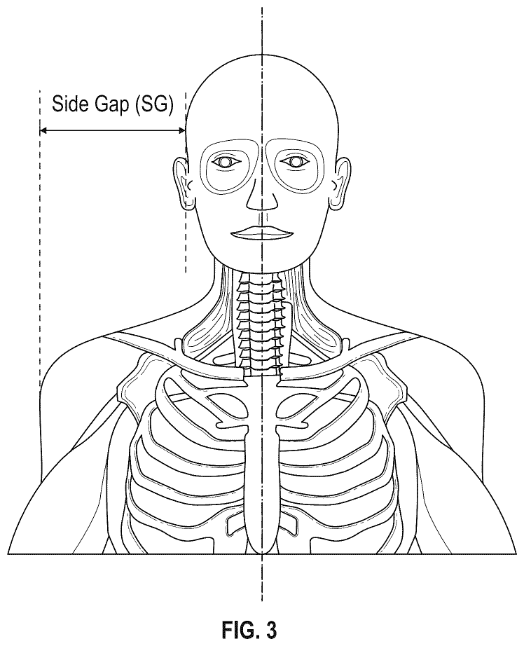

FIG. 4 is a diagrammatic illustration of a backset adjustment system for a vehicle in accordance with at least one embodiment of the present disclosure. In this example, the system is referred to by the reference numeral 400 and includes a vehicle 405, such as a car, and a vehicle control unit 410 located in the vehicle 405. The vehicle 405 may include a front portion 415a (including a front bumper), a rear portion 415b (including a rear bumper), a right side portion 415c (including a right front quarter panel, a right front door, a right rear door, and a right rear quarter panel), a left side portion 415d (including a left front quarter panel, a left front door, a left rear door, and a left rear quarter panel), and wheels 415e.

A communication module 420 is operably coupled to, and adapted to be in communication with, the vehicle control unit 410. The communication module 420 is adapted to communicate wirelessly with a central server 425 via a network 430 (e.g., a 3G network, a 4G network, a 5G network, a Wi-Fi network, or the like). The central server 425 may provide information and services including but not limited to include location, mapping, route or path, and topography information. Further, communication module 420 may communicate posture-related data over network 430 for statistical, accident or other data analysis purposes.

An operational equipment engine 440 is operably coupled to, and adapted to be in communication with, the vehicle control unit 410 and backset adjustment module 442 which is utilized to perform the techniques described herein. A sensor engine 450 is operably coupled to, and adapted to be in communication with, the vehicle control unit 410. Among other purposes, sensor engine 450 communicates with various sensors in and around vehicle 405 to detect, scan or otherwise determine physical parameters of seat occupants inside vehicle 405 or approaching vehicle 405 in order to automatically adjust the headrest BS as described herein. With reference back to FIG. 1B, backset adjustment module 442 is communicably coupled to vehicle seat 108 and the components thereof in order to adjust the backset based upon the recline angle of seat 108 and/or orientation of the seat occupant, as described herein.

An interface engine 455 is operably coupled to, and adapted to be in communication with, the vehicle control unit 410. In addition to, or instead of, being operably coupled to, and adapted to be in communication with, the vehicle control unit 410, the communication module 420, the operational equipment engine 440, the sensor engine 450, and/or the interface engine 455 may be operably coupled to, and adapted to be in communication with, another of the components via wired or wireless communication (e.g., via an in-vehicle network). In some examples, the vehicle control unit 410 is adapted to communicate with the communication module 420, the operational equipment engine 440, the sensor engine 450, and the interface engine 455 to at least partially control the interaction of data with and between the various components of backset adjustment system 400.

The term “engine” or “module” is meant herein to refer to an agent, instrument, or combination of either, or both, agents and instruments that may be associated to serve a purpose or accomplish a task—agents and instruments may include sensors, actuators, switches, relays, power plants, system wiring, computers, components of computers, programmable logic devices, microprocessors, software, software routines, software modules/engines, communication equipment, networks, network services, and/or other elements and their equivalents that contribute to the purpose or task to be accomplished by the engine. Accordingly, some of the engines may be software modules or routines, while others of the engines may be hardware and/or equipment elements in communication with any or all of the vehicle control unit 410, the communication module 420, the network 430, or a central server 425.

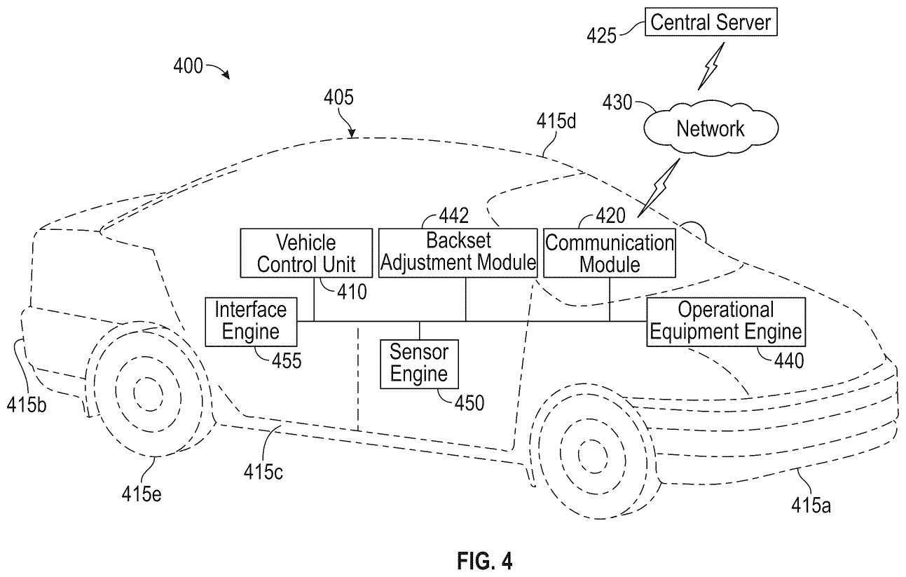

FIG. 5 is a flow chart for a method to adjust a vehicle head restraint backset based on a recline angle of a seat, according to certain illustrative embodiments of the present disclosure. With reference to at least FIGS. 1B and 4, at block 502 of method 500, backset adjustment system 400 obtains the recline angle of seat 108. The recline angle may be obtained in a variety of ways including, for example, using electromechanical techniques whereby the seat occupant initiates adjustment of the angle of back support 112 via a push button. Once the back support 112 is adjusted to the user's desired angle, backset adjustment system 400 detects the angle of back support 112 and adjusts head restraint 114 based upon the non-linear relationships described herein. Alternatively, one or more sensors in communication with sensor engine 450 and backset adjustment module 442 detects the orientation or other physical parameters of the seat occupant. Based upon this orientation or physical parameter data, backset adjustment system 400 then adjusts the backset, as described herein.

Thereafter, at block 504, backset adjustment system 400 adjusts the backset with respect to the recline angle of back support 112 based upon the non-linear relationship (e.g., Eq. (1), Eq. (2)) between the recline angle and backset. As described herein, the non-linear relationship is different for a driving posture recline angle range, resting posture recline angle range, and a sleeping posture recline angle range.

Alternatively, note in some embodiments, block 502 may not be necessary (hence the dotted lines). For example, in certain embodiments, the seat recline angles and corresponding backsets may be pre-set into memory. In such instances, a seat occupant may press a button to automatically adjust the seat to, e.g., Position 1, whereby the recline angle and backset are automatically adjusted accordingly. In such examples, it may not be necessary for the system to first detect the seat angle. In yet another example, seat 108 can be manually adjusted whereby the seat occupant can manually recline back support 112. Then, head restraint 114 automatically tilts as necessary to maintain a safe zone BS based upon the mechanical ratio. In such embodiments, the seat recline adjustment mechanism and head restraint adjustment mechanism are pre-set to the mechanical ratio, thus no detection of the seat recline angle would be necessary.

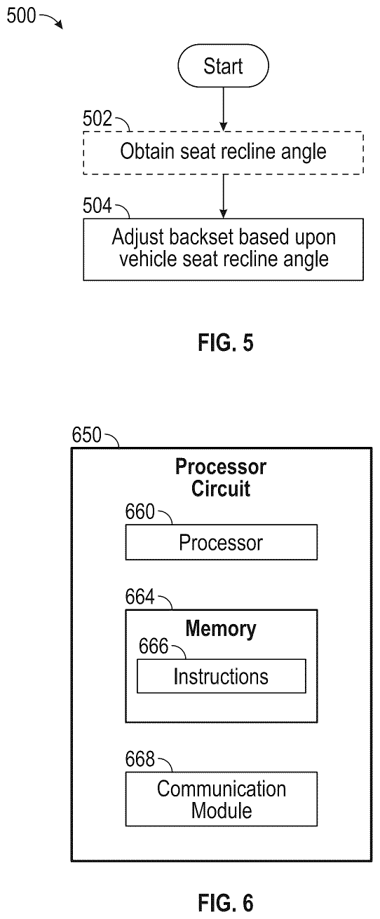

FIG. 6 is a schematic diagram of a processor circuit 650, in accordance with at least one embodiment of the present disclosure. The processor circuit 650 may be implemented in the system 400 (e.g., as part of backset adjustment module 442) or other devices or workstations (e.g., third-party workstations, network routers, etc.), or on a cloud processor or other remote processing unit, as necessary to implement the methods described herein. As shown, the processor circuit 650 may include a processor 660, a memory 664 having instructions 666 thereon, and a communication module 668. These elements may be in direct or indirect communication with each other, for example via one or more buses.

The processor 660 may include a central processing unit (CPU), a digital signal processor (DSP), an ASIC, a controller, or any combination of general-purpose computing devices, reduced instruction set computing (RISC) devices, application-specific integrated circuits (ASICs), field programmable gate arrays (FPGAs), or other related logic devices, including mechanical and quantum computers. The processor 660 may also comprise another hardware device, a firmware device, or any combination thereof configured to perform the operations described herein. The processor 660 may also be implemented as a combination of computing devices, e.g., a combination of a DSP and a microprocessor, a plurality of microprocessors, one or more microprocessors in conjunction with a DSP core, or any other such configuration.

The memory 664 may include a cache memory (e.g., a cache memory of the processor 660), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an embodiment, the memory 664 includes a non-transitory computer-readable medium. The memory 664 may store instructions 666. The instructions 666 may include instructions that, when executed by the processor 660, cause the processor 660 to perform the operations described herein. Instructions 666 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The communication module 668 can include any electronic circuitry and/or logic circuitry to facilitate direct or indirect communication of data between the processor circuit 650, and other processors or devices. In that regard, the communication module 668 can be an input/output (I/O) device. In some instances, the communication module 668 facilitates direct or indirect communication between various elements of the processor circuit 650 and/or the system 400. The communication module 668 may communicate within the processor circuit 650 through numerous methods or protocols. Serial communication protocols may include but are not limited to United States Serial Protocol Interface (US SPI), Inter-Integrated Circuit (I²C), Recommended Standard 232 (RS-232), RS-485, Controller Area Network (CAN), Ethernet, Aeronautical Radio, Incorporated 429 (ARINC 429), MODBUS, Military Standard 1553 (MIL-STD-1553), or any other suitable method or protocol. Parallel protocols include but are not limited to Industry Standard Architecture (ISA), Advanced Technology Attachment (ATA), Small Computer System Interface (SCSI), Peripheral Component Interconnect (PCI), Institute of Electrical and Electronics Engineers 488 (IEEE-488), IEEE-1284, and other suitable protocols. Where appropriate, serial and parallel communications may be bridged by a Universal Asynchronous Receiver Transmitter (UART), Universal Synchronous Receiver Transmitter (USART), or other appropriate subsystem.

External communication (including but not limited to software updates, firmware updates, preset sharing between the processor and central server, or readings from vehicle or environmental sensors) may be accomplished using any suitable wireless or wired communication technology, such as a cable interface such as a universal serial bus (USB), micro USB, Lightning, or FireWire interface, Bluetooth, Wi-Fi, ZigBee, Li-Fi, or cellular data connections such as 2G/GSM (global system for mobiles), 3G/UMTS (universal mobile telecommunications system), 4G, long term evolution (LTE), WiMax, or 5G. For example, a Bluetooth Low Energy (BLE) radio can be used to establish connectivity with a cloud service, for transmission of data, and for receipt of software patches. The controller may be configured to communicate with a remote server, or a local device such as a laptop, tablet, or handheld device, or may include a display capable of showing status variables and other information. Information may also be transferred on physical media such as a USB flash drive or memory stick.

Accordingly, the logical operations making up the embodiments of the technology described herein may be referred to variously as operations, steps, blocks, objects, elements, components, or modules. Furthermore, it should be understood that these may occur or be arranged in any order, unless explicitly claimed otherwise or a specific order is necessitated by the claim language or by the nature of the component or step.

These and other advantages will be readily apparent to those ordinarily skilled in the art having the benefit of this disclosure.

Methods and embodiments described herein further relate to any one or more of the following paragraphs:
1. A method to adjust a vehicle head restraint backset based on a recline angle of a seat, the method comprising: adjusting the backset with respect to a vehicle seat recline angle based upon a non-linear relationship between the vehicle seat recline angle and backset, wherein the non-linear relationship is different for a driving posture recline angle range, resting posture recline angle range, and a sleeping posture recline angle range.
2. The method as defined in paragraph 1, wherein the adjustment is performed automatically using a power motor.
3. The method as defined in paragraphs 1 or 2, wherein the adjustment is performed manually according to a predefined mechanical ratio of the vehicle seat to the head restraint.
4. The method as defined in any of paragraphs 1-3, wherein the driving posture recline angle range is 0°-35°.
5. The method as defined in any of paragraphs 1-4, wherein the resting posture recline angle range is 36°-54°.
6. The method as defined in any of paragraphs 1-5, wherein the sleeping posture recline angle range is above 54°.
7. The method as defined in any of paragraphs 1-6, wherein the sleeping posture recline angle range is divided into a back sleeping backset and side sleeping backset.
8. A system to adjust a vehicle head restraint backset based on a recline angle of a seat, the system comprising: a seat recline adjustment mechanism configured to recline the seat relative to a reference position; and a head restraint adjustment mechanism configured to adjust the backset with respect to the seat recline angle based upon a non-linear relationship between the seat recline angle and backset, wherein the non-linear relationship is different for a driving posture recline angle range, resting posture recline angle range, and a sleeping posture recline angle range.
9. The system as defined in paragraph 8, further comprising a processor communicably coupled to the seat recline angle adjustment mechanism and head restraint adjustment mechanism, the processor being configured to initiate automatic adjustment of the backset.
10. The system as defined in paragraphs 8 or 9, wherein the seat recline angle adjustment mechanism is manually actuated such that the head restraint adjustment mechanism, in response to manual actuation of the seat recline angle, automatically adjusts according to a predefined mechanical ratio of the seat to the head restraint.
11. The system as defined in any of paragraphs 8-10, wherein the driving posture recline angle range is 0°-35°.
12. The system as defined in any of paragraphs 8-11, wherein the resting posture recline angle range is 36°-54°.
13. The system as defined in any of paragraphs 8-12, wherein the sleeping posture recline angle range is above 54°.
14. The system as defined in any of paragraphs 8-13, wherein the sleeping posture recline angle range is divided into a back sleeping backset and side sleeping backset.
15. A vehicle, comprising: a seat having a back support and head restraint; a seat recline adjustment mechanism configured to recline the back support relative to a reference position; and a head restraint adjustment mechanism configured to adjust a backset of the head restraint with respect to a seat recline angle based upon a non-linear relationship between the seat recline angle and backset, wherein the non-linear relationship is different for a driving posture recline angle range, resting posture recline angle range, and a sleeping posture recline angle range.
16. The vehicle as defined in paragraph 15, further comprising a processor communicably coupled to the seat recline angle adjustment mechanism and head restraint adjustment mechanism, the processor being configured to initiate automatic adjustment of the backset.
17. The vehicle as defined in paragraphs 15 or 16, wherein the seat recline angle adjustment mechanism is manually actuated such that the head restraint adjustment mechanism, in response to manual actuation of the seat recline angle, automatically adjusts according to a predefined mechanical ratio of the seat to the head restraint.
18. The vehicle as defined in any of paragraphs 15-17, wherein the driving posture recline angle range is 0°-35°.
19. The vehicle as defined in any of paragraphs 15-18, wherein the resting posture recline angle range is 36°-54°.
20. The vehicle as defined in any of paragraphs 15-19, wherein the sleeping posture recline angle range is above 54°.

Moreover, the methods described herein may be embodied within a system comprising processing circuitry to implement any of the methods, or a in a non-transitory computer-readable medium comprising instructions which, when executed by at least one processor, causes the processor to perform any of the methods described herein.

All directional references e.g., upper, lower, inner, outer, upward, downward, left, right, lateral, front, back, top, bottom, above, below, vertical, horizontal, clockwise, counterclockwise, proximal, and distal are only used for identification purposes to aid the reader's understanding of the claimed subject matter, and do not create limitations, particularly as to the position, orientation, or use of the backset adjustment system. Connection references, e.g., attached, coupled, connected, and joined are to be construed broadly and may include intermediate members between a collection of elements. As such, connection references do not necessarily imply that two elements are directly connected and in fixed relation to each other. The term “or” shall be interpreted to mean “and/or” rather than “exclusive or.” Unless otherwise noted in the claims, stated values shall be interpreted as illustrative only and shall not be taken to be limiting.

The above specification, examples and data provide a complete description of the structure and use of exemplary embodiments of the backset adjustment system as defined in the claims. Although various embodiments of the claimed subject matter have been described above with a certain degree of particularity, or with reference to one or more individual embodiments, those skilled in the art could make numerous alterations to the disclosed embodiments without departing from the spirit or scope of the claimed subject matter. Additionally, sensors external to the vehicle may be employed to provide or supplement any of the sensor data described hereinabove. Alternatively, machine learning algorithms or other AI systems may be used to estimate variables from sparse, noisy, or entwined data streams without departing from the spirit of the present disclosure.

Still other embodiments are contemplated. It is intended that all matter contained in the above description and shown in the accompanying drawings shall be interpreted as illustrative only of particular embodiments and not limiting. Changes in detail or structure may be made without departing from the basic elements of the subject matter as defined in the following claims.

What is claimed is:

1. A method to adjust a vehicle head restraint backset based on a recline angle of a seat, the method comprising:
adjusting the backset with respect to a vehicle seat recline angle based upon a non-linear relationship between the vehicle seat recline angle and backset,
wherein the non-linear relationship is different for a driving posture recline angle range, resting posture recline angle range, and a sleeping posture recline angle range.

2. The method as defined in claim 1, wherein the adjustment is performed automatically using a power motor.

3. The method as defined in claim 1, wherein the adjustment is performed manually according to a predefined mechanical ratio of the vehicle seat to the head restraint.

4. The method as defined in claim 1, wherein the driving posture recline angle range is 0°-35°.

5. The method as defined in claim 1, wherein the resting posture recline angle range is 36°-54°.

6. The method as defined in claim 1, wherein the sleeping posture recline angle range is above 54°.

7. The method as defined in claim 6, wherein the sleeping posture recline angle range is divided into a back sleeping backset and side sleeping backset.

8. A system to adjust a vehicle head restraint backset based on a recline angle of a seat, the system comprising:
a seat recline adjustment mechanism configured to recline the seat relative to a reference position; and
a head restraint adjustment mechanism configured to adjust the backset with respect to the seat recline angle based upon a non-linear relationship between the seat recline angle and backset,
wherein the non-linear relationship is different for a driving posture recline angle range, resting posture recline angle range, and a sleeping posture recline angle range.

9. The system as defined in claim 8, further comprising a processor communicably coupled to the seat recline angle adjustment mechanism and head restraint adjustment mechanism, the processor being configured to initiate automatic adjustment of the backset.

10. The system as defined in claim 8, wherein the seat recline angle adjustment mechanism is manually actuated such that the head restraint adjustment mechanism, in response to manual actuation of the seat recline angle, automatically adjusts according to a predefined mechanical ratio of the seat to the head restraint.

11. The system as defined in claim 8, wherein the driving posture recline angle range is 0°-35°.

12. The system as defined in claim 8, wherein the resting posture recline angle range is 36°-54°.

13. The system as defined in claim 8, wherein the sleeping posture recline angle range is above 54°.

14. The system as defined in claim 13, wherein the sleeping posture recline angle range is divided into a back sleeping backset and side sleeping backset.

15. A vehicle, comprising:
a seat having a back support and head restraint;
a seat recline adjustment mechanism configured to recline the back support relative to a reference position; and
a head restraint adjustment mechanism configured to adjust a backset of the head restraint with respect to a seat recline angle based upon a non-linear relationship between the seat recline angle and backset,
wherein the non-linear relationship is different for a driving posture recline angle range, resting posture recline angle range, and a sleeping posture recline angle range.

16. The vehicle as defined in claim 15, further comprising a processor communicably coupled to the seat recline angle adjustment mechanism and head restraint adjustment mechanism, the processor being configured to initiate automatic adjustment of the backset.

17. The vehicle as defined in claim 15, wherein the seat recline angle adjustment mechanism is manually actuated such that the head restraint adjustment mechanism, in response to manual actuation of the seat recline angle, automatically adjusts according to a predefined mechanical ratio of the seat to the head restraint.

18. The vehicle as defined in claim 15, wherein the driving posture recline angle range is 0°-35°.

19. The vehicle as defined in claim 15, wherein the resting posture recline angle range is 36°-54°.

20. The vehicle as defined in claim 15, wherein the sleeping posture recline angle range is above 54°.
